(19) United States
(12) Patent Application Publication
(10) Pub. No.: US 2014/0256332 A1
(43) Pub. Date: Sep. 11, 2014

(54) INTERFERENCE COORDINATION BETWEEN MACROCELL AND SMALL CELL

(71) Applicant: Nokia Corporation, Espoo (FI)

(72) Inventors: Kodo Shu, Beijing (CN); Guoqing Jia, Shanghai (CN); Xiumei Yang, Shanghai (CN); Honglin Hu, Shanghai (CN)

(21) Appl. No.: 14/350,334

(22) PCT Filed: Oct. 13, 2011
(86) PCT No.: PCT/CN2011/080744

§ 371 Date: Apr. 7, 2014

(51) Int. Cl. H04W 16/02; H04W 16/32

(52) U.S. Cl. CPC H04W 16/02; H04W 16/32
USPC 455/447

(57) ABSTRACT

Provided are methods, corresponding apparatus and computer program products for interference coordination between a macrocell and a small cell. A method comprises receiving respective position information from at least one small-cell base station and at least one macrocell user equipment; calculating a distance between the at least one small-cell base station and the at least one macrocell user equipment based upon the respective position information; and determining, based upon the distance, whether to allow the at least one small-equipment cell base station to reuse radio resources used by the at least one macrocell user equipment. With the embodiments, the interference coordination can be improved and thus interference in small-cell transmission will be diminished due to efficient allocation and usage of the radio resources.

### FIELD OF THE INVENTION

Embodiments of the present invention generally relate to wireless communication techniques including the 3GPP (the 3rd Generation Partnership Project) LTE (Long Term Evolution) technique. More particularly, embodiments of the present invention relate to methods, apparatus and computer program products for interference coordination between a macrocell and a small cell (e.g., a femtocell or a picocell).

### BACKGROUND OF THE INVENTION

Various abbreviations that appear in the specification and/or in the drawing figures are defined as below:

BS Base Station

FBS Femtocell Base Station

MBS Macrocell Base Station

UE User Equipment

FUE Femtocell User Equipment

MUE Macrocell User Equipment

LTE-A Long Term Evolution Advanced

PRS Positioning Reference Signal

CRS Cell-specific Reference Signal

PRB Physical Resource Block

OTDOA Observed Time Difference of Arrival

GPS Global Positioning System

With developments of communication techniques, the use of small cells for wireless access has become more and more popular among network operators or users. Take femtocells as an example of small cells. Femtocells have received a significant amount of attention from industry and academia recently due to their tremendous potential for capacity improvements and coverage extension. For a better understanding of the femtocells, discussion will be made in connection with FIG. 1.

FIG. 1 schematically illustrates architecture of co-channel deployment of such femtocells in a macrocell. As illustrated in FIG. 1, an MBS in the macrocell is in communication with MUEs and FBSs, which include the MUE A and adjacent FBS A, MUE B and adjacent FBS B. The respective coverage areas of the MBS and FBSs are exemplarily depicted by circles; the bigger circle represents a macrocell covered by the MBS and two smaller circles each represent a femtocell (i.e., a femtocell network) covered by the respective FBS. It can be noted from the coverage areas that the MUEs are only served by the MBS rather than by the FBSs.

In the architecture as illustrated in FIG. 1, the introduced FBSs in the macrocell may interfere with the MUEs. To avoid or ameliorate such interference caused by coexistence of the macrocell and the femtocell, several interference coordination solutions have been developed, including, e.g., a frequency resource partition solution, a power control solution, and an energy measurement based solution.

### SUMMARY OF THE INVENTION

Current solutions, however, are still not highly efficient in coordinating interference for reasons as discussed below.

First, for the frequency resource partition and power control solutions, the frequency resource partition may decrease the frequency utilizing efficiency and the power controlled femtocells may incur serious interference to each other in some cases, because a UE distant to one femtocell may use high power to maintain communication connection; however, this UE could be close to another femtocell (positions of UEs are unknown and handovers may be imperfect) and then it may cause serious interference thereto.

Second, for the energy measurement based solution, an FBS may sense uplink PRB energy and then send a PRB energy pattern to an MBS. The MBS may, based upon the PRB energy pattern, search a resource allocation history database and identify PRBs of those UEs which could be strong interference to the FBS. Afterwards, orthogonal PRBs corresponding to those UEs will be allocated to the FBS for uplink and downlink transmission. The main drawbacks of this coordination solution are: 1)the PRB allocation scheme is varying every millisecond for the MBS but processing and transmitting the PRB energy pattern from the FBS to MBS may take one second; therefore, processing delay will deteriorate performance of this coordination solution; 2) this coordination solution is not robust because channel fast-fading may incur an inaccurate energy pattern, which may result in strong interference. Similar drawbacks may also exist in picocells.

Therefore, there is a need in the art to provide for an efficient way of interference coordination between a macrocell and a small cell so that no strong interference is present or incurred under a loose deployment of the macrocell and the small cell. Further, flexibility and efficiency of use of radio resources can be boosted upon the interference coordination.

One embodiment of the present invention provides a method. The method comprises receiving respective position information from at least one small-cell base station and at least one macrocell user equipment. The method also comprises calculating a distance between the at least one small-cell base station and the at least one macrocell user equipment based upon the respective position information. Further, the method comprises determining, based upon the distance, whether to allow the at least one small-cell base station to reuse radio resources used by the at least one macrocell user equipment.

In one embodiment, the determining comprises comparing the distance with a predetermined threshold and determining allowing the at least one small-cell base station to reuse the radio resources if the distance is equal to or greater than the predetermined threshold.

In another embodiment, the method further comprises: responsive to allowing reusing of the radio resources, signaling an indication regarding the radio resources to the at least one small-cell base station. The method further comprises calculating distances between the small-cell base stations that have been allowed to reuse the radio resources and determining, based upon the distances, allocation of the radio resources between the small-cell base stations.

In an additional embodiment, the at least one small-cell base station comprises one of a femtocell base station and a picocell base station, and one of the small-cell base stations that have been allowed to reuse the radio resources comprises one of a femtocell base station and a picocell base station.

Another embodiment of the present invention provides a method. The method comprises receiving position information from at least two small-cell base stations. The method also comprises calculating a distance between the at least two small-cell base stations. Further, the method comprises determining, based upon the distance, whether to allocate same radio resource to the at least two small-cell base stations.

In another embodiment, the method further comprises: comparing the distance with a predetermined threshold; and determining allocating the same radio resource to the at least two small-cell base stations if the distance is equal to or greater than the predetermined threshold.

In a further embodiment, one of the at least two small-cell base stations comprises one of a femtocell base station and a picocell base station.

One embodiment of the present invention provides an apparatus. The apparatus comprises means for receiving respective position information from at least one small-cell base station and at least one macrocell user equipment. The apparatus also comprises means for calculating a distance between the at least one small-cell base station and the at least one macrocell user equipment based upon the respective position information. Further, the apparatus comprises means for determining, based upon the distance, whether to allow the at least one small-cell base station to reuse radio resources used by the at least one macrocell user equipment.

Another embodiment of the present invention provides an apparatus. The apparatus comprises means for receiving position information from at least two small-cell base stations. The apparatus also comprises means for calculating a distance between the at least two small-cell base stations. Further, the apparatus comprises means for determining, based upon the distance, whether to allocate same radio resource to the at least two small-cell base stations.

An additional embodiment of the present invention provides a macrocell base station. The macrocell base station comprises an apparatus as provided by any embodiment of the invention and as discussed above or below.

A further embodiment of the present invention provides an apparatus. The apparatus comprises at least one processor and at least one memory including computer program code. The memory and the computer program code are configured to cause the apparatus to receive respective position information from at least one small-cell base station and at least one macrocell user equipment. The memory and the computer program code are also configured to cause the apparatus to calculate a distance between the at least one small-cell base station and the at least one macrocell user equipment based upon the respective position information. Further, the memory and the computer program code are also configured to cause the apparatus to determine, based upon the distance, whether to allow the at least one small-cell base station to reuse radio resources used by the at least one macrocell user equipment.

An additional embodiment of the present invention provides an apparatus. The apparatus comprises at least one processor and at least one memory including computer program code. The memory and the computer program code are configured to cause the apparatus to receive position information from at least two small-cell base stations. The memory and the computer program code are also configured to cause the apparatus to calculate a distance between the at least two small-cell base stations. Further, the memory and the computer program code are also configured to cause the apparatus to determine, based upon the distance, whether to allocate same radio resource to the at least two small-cell base stations.

One embodiment of the present invention provides a computer program product, comprising at least one computer readable storage medium having a computer readable program code portion stored thereon. The computer readable program code portion comprises program code instructions for receiving respective position information from at least one small-cell base station and at least one macrocell user equipment. The computer readable program code portion also comprises program code instructions for calculating a distance between the at least one small-cell base station and the at least one macrocell user equipment based upon the respective position information. Further, the computer readable program code portion comprises program code instructions for determining, based upon the distance, whether to allow the at least one small-cell base station to reuse radio resources used by the at least one macrocell user equipment.

Another embodiment of the present invention provides a computer program product, comprising at least one computer readable storage medium having a computer readable program code portion stored thereon. The computer readable program code portion comprises program code instructions for receiving position information from at least two small-cell base stations. The computer readable program code portion also comprises program code instructions for calculating a distance between the at least two small-cell base stations. Further, the computer readable program code portion comprises program code instructions for determining, based upon the distance, whether to allocate same radio resource to the at least two small-cell base stations.

According to certain embodiments of the present invention, because accurate position information of the small-cell BSs and MUEs (with low mobility) can be obtained via small-cell BSs measurements or MUEs feedbacks, distances between the small-cell BSs and those between the small-cell BSs and the MUEs can be determined precisely. Based upon the precise distances, radio resources can be reused and allocated among the small-cell BSs such that the interference between the small-cell BSs and the MBS and those between the small-cell BSs can be diminished efficiently, resulting in better interference coordination. In addition, by means of the reusing and allocation, flexibility and efficiency of use of the radio resources will be improved or boosted.

Other features and advantages of the embodiments of the present invention will also be understood from the following description of specific embodiments when read in conjunction with the accompanying drawings, which illustrate, by way of example, the principles of embodiments of the invention.

### BRIEF DESCRIPTION OF THE DRAWINGS

The embodiments of the invention that are presented in the sense of examples and their advantages are explained in greater detail below with reference to the accompanying drawings, in which:

FIG. 1 is a schematic diagram illustrating architecture of co-channel deployment of femtocells in a macrocell;

FIG. 2 is a schematic diagram illustrating architecture of co-channel deployment of femtocell networks in a macrocell, in which certain embodiments of the present invention can be implemented;

FIG. 3 is a flow chart schematically illustrating a method for interference coordination between a macrocell and a small cell according to an embodiment of the present invention;

FIG. 4 is a flow chart schematically illustrating a method for interference coordination between a macrocell and a small cell according to another embodiment of the present invention;

FIG. 5 is a detailed flow chart schematically illustrating a method for interference coordination between a macrocell and a femtocell according to an embodiment of the present invention; and

FIG. 6 is a schematic block diagram of an MBS for performing interference coordination between a macrocell and a small cell according to an embodiment of the present invention.

### DETAILED DESCRIPTION OF EMBODIMENTS

Embodiments of the present invention propose position information based resource reuse schemes (e.g., reuse of PRBs at one carrier or component carrier), by which co-channel deployed small cells would not cause serious interference to macrocell transmission. According to certain embodiments of the present invention, an MBS receives position information from small cell BSs and MUEs and calculates distances between the small-cell BSs and those between the small-cell BSs and MUEs. Based upon the distances between the small-cell BSs and MUEs, the MBS determines which small-cell BSs are allowed to reuse radio resources used by the MUEs. Similarly, based upon the distances between the small-cell BSs, the MBS can determine whether to allow the small-cell BSs to use same radio resource. In the embodiments of the present invention, the radio resources (i.e., time-frequency resources) may, as appropriate, refer to a portion of the PRBs at one carrier or one component carrier within a set of component carriers.

Embodiments of the present invention will be described in detail as below.

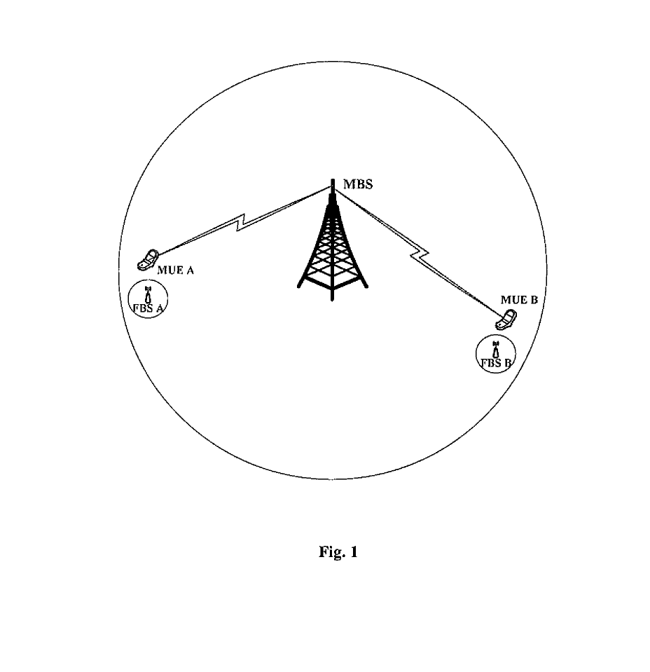

FIG. 1 is a schematic diagram illustrating architecture of co-channel deployment of femtocells (one kind of small cells, as noted previously) in a macrocell, which has been previously discussed and thus its description is omitted herein for conciseness.

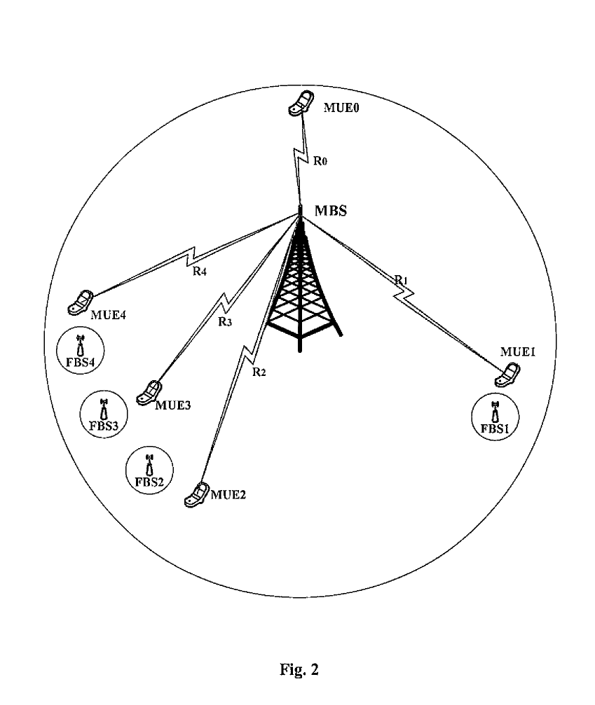

FIG. 2 is a schematic diagram illustrating architecture of co-channel deployment of femtocells in a macrocell, in which certain embodiments of the present invention can be practiced. It can be seen that FIG. 2 is similar to FIG. 1, except that more FBSs and MUEs have been depicted, and reference numbers R0, R1, R2, R3, and R4, which represent respective radio resources of the MUEs 0-4, have been labeled. Further, although not illustrated in FIG. 2, one or more picocells may also be deployed under the above architecture and communicate with the MBS.

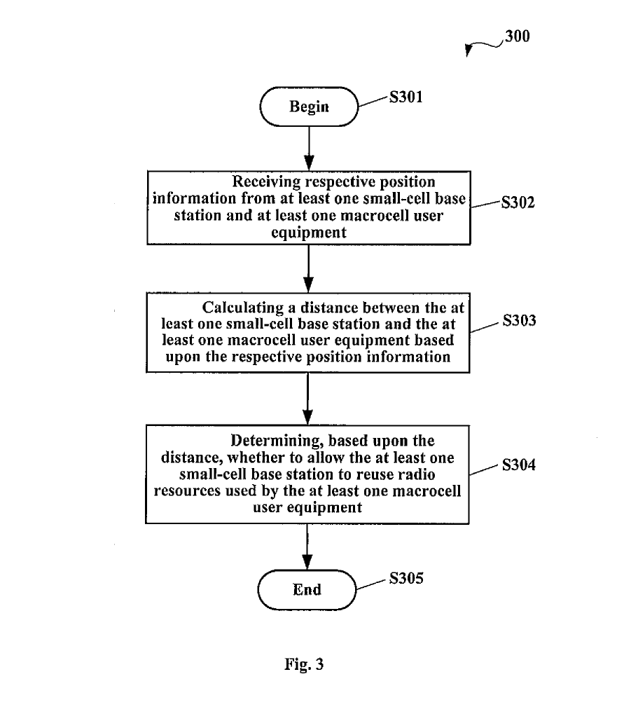

FIG. 3 is a flow chart schematically illustrating a method 300 for interference coordination between a macrocell and a small cell according to an embodiment of the present invention. As illustrated in FIG. 3, the method 300 begins at step S301 and receives respective position information from at least one small-cell BS and at least one MUE at step S302. In some embodiments, the respective position information can be estimated or acquired at the respective small-cell BS and MUE by the OTDOA in a cellular system or by GPS signals in a GPS system, and can be received via an X2 interface and an uplink signaling signal, respectively. Further, given the potential movement of the small-cell BSs and the MUE, it is preferable to estimate or acquire the position information periodically such that its accuracy could be maintained at a high or decent level.

Upon receiving the respective position information, the method 300 proceeds to step S303 at which the method 300 calculates a distance between the at least one small-cell BS and the at least one MUE based upon the respective position information. In some embodiments, the method 300 may calculate every distance between each small-cell BS and MUE exhaustively when the number of the small-cell BSs or MUEs is equal to or greater than two.

Afterwards, the method 300 advances to step S304, at which the method 300 determines, based upon the distance, whether to allow the at least one small-cell BS to reuse radio resources used by the at least one MUE. In some embodiments, the method 300 compares the calculated distance with a predetermined threshold. For example, when the coverage area of the small-cell BS is dozens of meters, then the predetermined threshold can be set to 0.5 or 1 km. If the calculated distance is equal to or greater than the predetermined threshold, it is then determined that the corresponding small-cell BS is allowed to reuse the radio resources as having been used by the corresponding MUE. Otherwise, the corresponding small-cell BS is not eligible for reusing the radio resources because it may cause potential or even strong interference to the corresponding MUE which is adjacent to or not far away from the corresponding small-cell BS.

Finally, the method 300 ends at step S305.

Although not illustrated in FIG. 3, in some embodiments, the method 300 may further comprise responsive to allowing reusing of radio resources, signaling an indication regarding the radio resources to the at least one small-cell BS, e.g., through an X2 interface signaling signal. The method 300 may further comprise calculating distances between the small-cell BSs that have been allowed to reuse the radio resources, and determining, based upon the distances, allocation of the radio resources between the small-cell BSs. This is exactly the case in which a plurality of the small-cell BSs are theoretically allowed to reuse the same radio resources. Because the plurality of the small-cell BSs may be close or adjacent to each other, it is necessary to further allocate or divide the radio resources among them so as to avoid mutual interference.

The foregoing has discussed certain embodiments of the present invention in connection with the method 300 as illustrated in FIG. 3, and hereinafter, the method 300 will be further discussed under the architecture as illustrated in FIG. 2 with the small-cell BS being implemented as an FBS.

As illustrated in FIG. 2 and according to the steps as described in the method 300, the MBS receives the respective position information from the FBSs 1-4 and MUEs 0-4. Based upon the received respective position information, the MBS calculates the distances between each FBS and MUE and those between the FBSs. All things being equal, the MBS determines, based upon the corresponding distances, the reusing of the radio resources as below:

The R0 can be reused by the FBS1, or can be reused by one of the FBSs 2-4, or can be reused by the MUEs 2 and 4, or can be divided among the MUEs 2-4;

The R1 can be reused by the FBSs 2-4, respectively;

The R2 can be reused by the FBSs 1 and 4;

The R3 can be reused by the FBS 1; and

The R4 can be reused by the FBSs 1 and 2.

In the above exemplary reusing, because MUE 0 is not adjacent to any FBS, its radio resource R0 can be reused in much more flexible ways. Further, due to their proximity, the FBSs 2-4 cannot reuse the R0 or R1 simultaneously; otherwise, interference may arise among them. To this end, the MBS may allocate the R0 or R1 only to the FBSs 2 and 4 since the FBSs 2 and 4 are distant from each other. Also, the MBS may allocate the R0 or R1 to one of the FBSs 2-4 according to the amount of traffic or under consideration of priority. It is apparent that the radio resources can be allocated flexibly dependent on various communication needs or conditions. In addition, the above allocation may be performed or coordinated locally on the FBSs' own, e.g., via X2 interfaces therebetween.

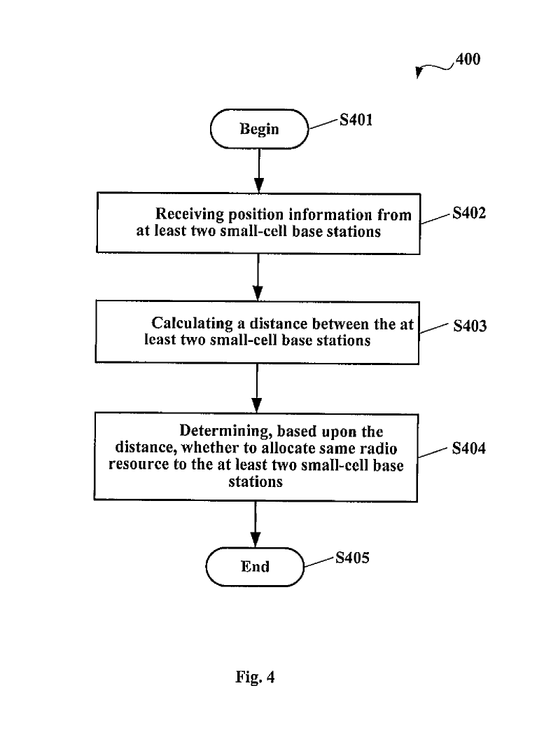

FIG. 4 is a flow chart schematically illustrating a method 400 for interference coordination between a macrocell and a small cell according to another embodiment of the present invention. As illustrated in FIG. 4, the method 400 begins at step S401 and receives position information from at least two small-cell BSs at step S402. As noted before, the position information can be estimated or acquired at the corresponding small-cell BSs by the OTDOA in a cellular system or by GPS signals in a GPS system, and can be received at an MBS via an X2 interface.

Upon receipt of the position information, the method 400 proceeds to step S403, at which the method 400 calculates a distance between the at least two small-cell BSs. After that, the method 400 advances to step S404, wherein the method 400 determines, based upon the distance, whether to allocate same radio resource to the at least two small-cell BSs. For example, the method 400 may compare the calculated distance with a predetermined threshold, and may allow the two small-cell BSs to use the same radio resource only if the distance is equal to or greater than the predetermined threshold. Finally, the method 400 ends at step S405.

With the method 400 as illustrated above, the small-cell BSs that are mutually distant are allowed to use the same radio resource. For example, the FBSs 1, 2, and 4, as illustrated in FIG. 2, are pairwise distant and thus eligible to be allocated with the same radio resource. In this manner, the limited radio resources in femtocell transmission can be applied flexibly and efficiently, which also leads to better interference coordination.

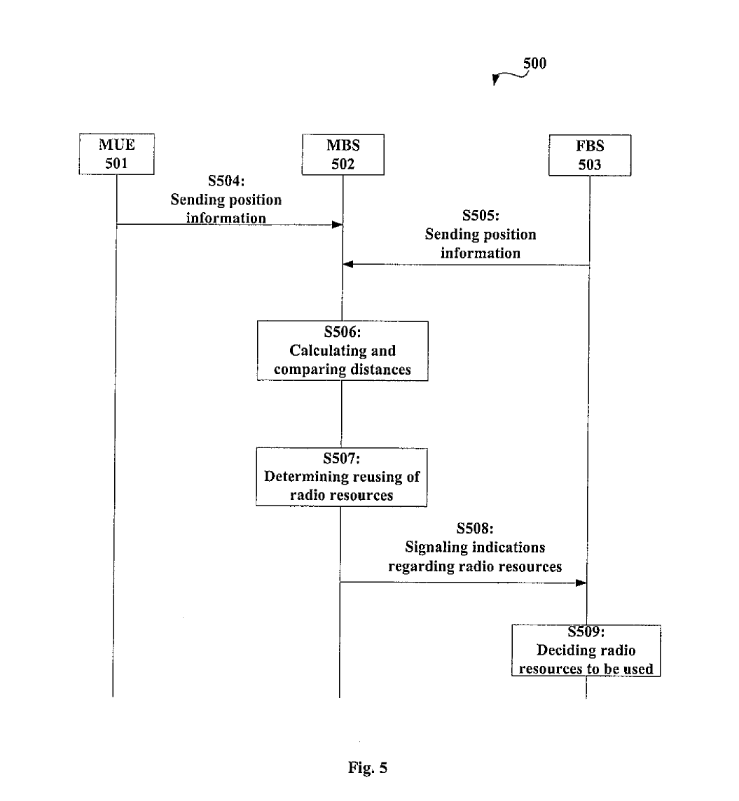

FIG. 5 is a detailed flow chart schematically illustrating a method 500 for interference coordination between a macrocell and a small cell (embodied as a femtocell herein) according to an embodiment of the present invention. As illustrated in FIG. 5, the method 500 begins at step S504 wherein the MUE 501 sends position information to the MBS 502, e.g., periodically. As discussed before, the position information can be obtained by the OTDOA in a cellular system or by a GPS system if GPS signals are sufficiently strong. Additionally, the LTE system uses a CRS signal in positioning and the LTE-A system introduces a PRS signal to enhance accuracy of the positioning. The positioning error could be within a distance of 20 m by 90% probability when the MUE's mobile velocity is low, e.g., 3 km per hour when the user is walking. That is to say, the precise or accurate position information can be obtained when the position of the MUE 501 remains unchanged or changes slowly.

Then, the method 500 proceeds to step S505, at which the FBS 503 also sends its position information to the MBS 502 via e.g., an X2 interface. Similar to the MUE 501, the position information of the FBS 503 can be acquired by the OTDOA, and if the FBS 503 is located in an outdoor environment, then its position information can also be obtained by GPS signals provided through a GPS system. Because the deployment of the FBS 503 is generally quasi-static, a high accuracy of the position information can be achieved. In addition, in view of the likelihood that the FBS 503 may be moved to other places manually, it is preferable to obtain or estimate the position information periodically.

Upon receipt of the respective position information of the MUE 501 and the FBS 503, the method 500 advances to step S506, wherein the MBS 502 calculates the distance between the MUE 501 and the FBS 503 and compares it with a predetermined threshold. The predetermined threshold may be an empirical value dependent on the interference. For example, in one embodiment, when the coverage area of the FBS 503 is several hundred square meters, a distance of 1 km between the FBS and the MUE might be sufficiently far. Thus, when the distance is equal to or greater than the predetermined threshold, then at Step S507, the MBS 502 determines and allows the FBS 503 to reuse the time-frequency resources that have been used by the MUE 501. Next, the method 500 proceeds to step S508, at which the MBS 502 signals an indication regarding the radio resources to the FBS 503 via an X2 interface. Upon receipt of the indication, the FBS 503, at step S509, decides how to reuse these allowed radio resources on its own. For example, the FBS 503 may determine whether to use these radio resources all or just some of them in view of the existing radio resources, the number of the served user equipments (i.e., amount of traffic), or the radio resources of the adjacent FBS, and so on.

The foregoing has discussed, in connection with FIG. 5, the method 500 which may involve further implemental details or variants of the method 300, and it is apparent that the present invention is not limited thereto. For example, although FIG. 5 only illustrates one MUE and one FBS (i.e., one small-cell BS) that send the respective position information to the MBS, it is clear that a plurality of MUEs and FBSs may send such position information to the MBS and then the MBS may calculate a plurality of corresponding distances. Again, although not illustrated in FIG. 5, it should be noted that the MBS may determine more than one FBS are qualified to reuse the radio resources used by certain MUEs. Due to the fact that adjacent FBSs using the same radio resources may cause interference, coordination should be made among the FBSs in question such that different portions of the same radio resources can be reused by different FBSs or only one of the qualified FBS may reuse the whole radio resources, as discussed previously with FIG. 2. Additionally, based upon the distances between the FBSs, the MBS may allocate same radio resource to a plurality of distant FBSs, as discussed previously with the method 400.

It should be noted herein that the steps and execution order as illustrated FIG. 5 are only examples and are not restrictive to the present invention. Those skilled in the art, after reading the present specification, can change these steps, for example, by omitting, combining, or adding certain steps, changing the execution order of certain steps so as to adapt to different application demands. For example, the order of steps S504 and S505 can be switched or both steps can occur simultaneously. In addition, although the foregoing has taken the FBS as an example of a small-cell BS in discussing the method 500, it should be noted that a picocell BS also can be applied in the method 500.

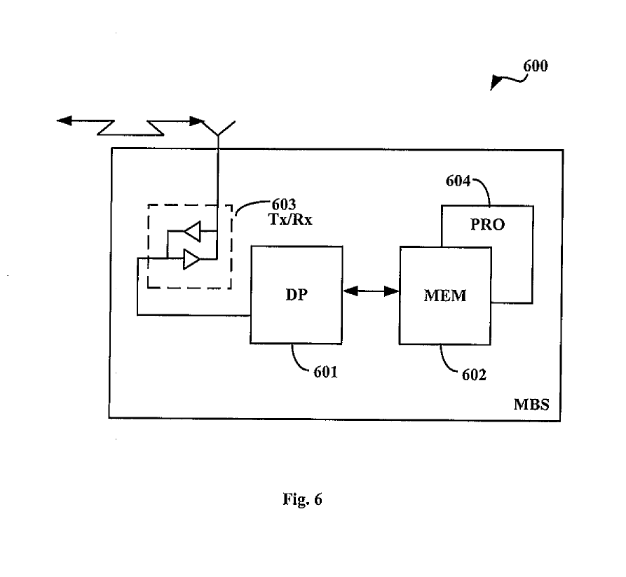

FIG. 6 is a schematic block diagram of an MBS 600 for performing interference coordination between a macrocell and a small cell according to an embodiment of the present invention. As illustrated in FIG. 6, the MBS 600 includes a data processor (DP) 601, a memory (MEM) 602 coupled to the DP 601, and a suitable RF transmitter TX and receiver RX 603 coupled to the DP 601. The MEM 602 stores a program (PROG) 604. The TX/RX 603 is for bidirectional wireless communications with the MUEs or small-cell BSs. Note that the TX/RX 603 has at least one antenna to facilitate communication, though in practice the MBS 600 will typically have several. Also, note that individual circuits and elements that may be necessary for operation of the MBS 600 are omitted herein so as not to obscure embodiments of the present invention unnecessarily.

The PROG 604 is assumed to include program instructions that, when executed by the associated DP 601, enable the MBS 600 to perform methods in accordance with the exemplary embodiments of the present invention, as discussed previously. The embodiments of the present invention may be implemented by computer software executable by the DP 601 of the MBS 600, or by hardware, or by a combination of software and hardware.

The MEM 602 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM 602 is shown, there may be several physically distinct memory units in the MBS 600. The DP 601 may be of any type suitable to the local technical environment, and may include one or more of general purpose computers, special purpose computers, microprocessors, digital signal processors (DSPs) and processors based on multi core processor architecture, as non limiting examples. The MBS 600 may have multiple processors, such as an application specific integrated circuit chip that is slaved in time to a clock which synchronizes the main processor.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-21. (canceled)

22. A method, comprising:
receiving respective position information from at least one small-cell base station and at least one macrocell user equipment;
calculating periodically a distance between the at least one small-cell base station and the at least one macrocell user equipment based upon the respective position information;
determining, based upon the distance, whether to allow the at least one small-cell base station to reuse radio resources used by the at least one macrocell user equipment; and
signaling, responsive to allowing reusing of the radio resources, an indication regarding the radio resources used by the at least one macrocell user equipment to the at least one small-cell base station.

23. The method as recited in claim 22, wherein the determining comprises:
comparing the distance with a predetermined threshold; and
determining allowing the at least one small-cell base station to reuse the radio resources if the distance is equal to or greater than the predetermined threshold.

24. The method as recited in claim 22, further comprising:
calculating distances between small-cell base stations that have been allowed to reuse the radio resources; and
determining, based upon the distances, allocation of the radio resources between the small-cell base stations.

25. The method as recited in claim 22, wherein the at least one small-cell base station comprises one of a femtocell base station and a picocell base station, and wherein one of the small-cell base stations that have been allowed to reuse the radio resources comprises one of a femtocell base station and a picocell base station.

26. A method, comprising:
receiving position information from at least two small-cell base stations;
calculating a distance between the at least two small-cell base stations; and
determining, based upon the distance, whether to allocate same radio resource to the at least two small-cell base stations.

27. The method as recited in claim 26, wherein the determining comprises:
comparing the distance with a predetermined threshold; and
determining allocating the same radio resource to the at least two small-cell base stations if the distance is equal to or greater than the predetermined threshold.

28. The method as recited in claim 26, wherein one of the at least two small-cell base stations comprises one of a femtocell base station and a picocell base station.

29. An apparatus, comprising:
at least one processor and at least one memory including compute program code,
the memory and the computer program code configured to cause the apparatus to perform:
receive respective position information from at least one small-cell base station and at least one macrocell user equipment;
calculate periodically a distance between the at least one small-cell base station and the at least one macrocell user equipment based upon the respective position information;
determine, based upon the distance, whether to allow the at least one small-cell base station to reuse radio resources used by the at least one macrocell user equipment; and
signal, responsive to allowing reusing of the radio resources, an indication regarding the radio resources used by the at least one macrocell user equipment to the at least one small-cell base station.

30. The apparatus as recited in claim 29, wherein the determining comprises:
comparing the distance with a predetermined threshold; and
determining allowing the at least one small-cell base station to reuse the radio resources if the distance is equal to or greater than the predetermined threshold.

31. The apparatus as recited in claim 29, wherein the apparatus is further caused to:
calculate distances between small-cell base stations that have been allowed to reuse the radio resources; and
determine, based upon the distances, allocation of the radio resources between the small-cell base stations.

32. The apparatus as recited in claim 29, wherein the at least one small-cell base station comprises one of a femtocell base station and a picocell base station, and wherein one of the small-cell base stations that have been allowed to reuse the radio resources comprises one of a femtocell base station and a picocell base station.

33. An apparatus, comprising:
at least one processor and at least one memory including compute program code,
the memory and the computer program code configured to cause the apparatus to perform:
receive position information from at least two small-cell base stations;
calculate a distance between the at least two small-cell base stations; and
determine, based upon the distance, whether to allocate same radio resource to the at least two small-cell base stations.

34. The apparatus as recited in claim 33, wherein the determining comprises:
comparing the distance with a predetermined threshold; and
determining to allocate the same radio resource to the at least two small-cell base stations if the distance is equal to or greater than the predetermined threshold.

35. The apparatus as recited in claim 33, wherein one of the at least two small-cell base stations comprises one of a femtocell base station and a picocell base station.
